(19) United States
(12) Patent Application Publication
(10) Pub. No.: US 2026/0077991 A1
(43) Pub. Date: Mar. 19, 2026

(54) BEVERAGE DISPENSING MACHINES WITH FIXED RATIO MECHANICAL VALVES

(71) Applicant: Marmon Foodservice Technologies, Inc., Osseo, MN (US)

(72) Inventors: Brian Mastro, Des Plaines, IL (US); Chris Coul, Geneva, IL (US)

(73) Assignee: Marmon Foodservice Technologies, Inc., Osseo, MN (US)

(21) Appl. No.: 19/325,348

(22) Filed: Sep. 10, 2025

Related U.S. Application Data
(60) Provisional application No. 63/694,607, filed on Sep. 13, 2024.

(51) Int. Cl. B67D 1/00; B67D 1/12

(52) U.S. Cl. CPC B67D 1/0029; B67D 1/1204

(57) ABSTRACT

A beverage dispensing valve includes a valve body with an aperture along the flow path, where an orifice can be removably positioned. The valve may feature multiple orifices with varying diameters. A flow restrictor is configured to regulate syrup flow, while a flow control lock is configured to limit adjustment of the flow restrictor.

### CROSS-REFERENCE TO RELATED APPLICATION

The present application claims priority of U.S. Provisional Ser. No. 63/694,607, filed on Sep. 13, 2024, the contents of which are incorporated by reference herein in its entirety.

### BACKGROUND

Beverage dispensing machines are widely used to dispense beverages to operators in different settings (e.g., restaurants, convenience stores), and the machines can be configured to dispense a variety of beverages. In certain examples, the machines include beverage dispensing valves that are each configured to dispense a specific mixed beverage to the operator. The valve receives and dispenses one or more diluents or base fluids (e.g., still water, carbonated water) and one or more concentrates (e.g., soda syrup concentrate) that mix together and thereby form the mixed beverage.

Existing technologies in the field of mechanical valves for fluid control often face challenges related to maintaining fixed flow ratios. Many current systems utilize adjustable flow control mechanisms, which, while offering flexibility, can lead to variability in the dispensed product. This variability can result from factors such as wear and tear, manual adjustments, or environmental conditions affecting the valve's performance. Additionally, the need for frequent recalibration of these systems can lead to increased maintenance costs and downtime, impacting operational efficiency.

Beverage dispensing machines are widely used to dispense beverages to operators in different settings (e.g., restaurants, convenience stores), and the machines can be configured to dispense a variety of beverages. In certain examples, the machines include beverage dispensing valves that are each configured to dispense a specific mixed beverage to the operator. The valve receives and dispenses one or more diluents or base fluids (e.g., still water, carbonated water) and one or more concentrates (e.g., soda syrup concentrate) that mix together and thereby form the mixed beverage.

U.S. Pat. No. 11,702,331 discloses beverage dispensing machines with dispensing valves in which a sensed flow rate is used to meter a flow rate of a syrup and/or diluent of a mixed beverage to maintain a predetermined ratio of syrup and diluent in the mixed beverage.

U.S. Pat. No. 7,290,680 discloses a post-mix beverage valve that provides for automatic, accurate beverage ratioing. A valve body can be assembled, and includes a water flow hard body, syrup body and common nozzle body. The water and syrup flow bodies define flow channels and include one end for connection to water and syrup respectively, and opposite ends for fluid connection to the nozzle body. The water flow channel includes a turbine flow sensor connected to a micro-controller determining the water flow rate. A stepper motor on the water body controls a rod in the flow channel in conjunction with a V-groove.

U.S. Pat. No. 10,408,356 discloses a valve that includes a housing defining a chamber with an inlet for receiving a fluid and an outlet for dispensing the fluid. A piston is located in the chamber and subjected to a fluid pressure exerted by the fluid received via the inlet. A plunger is received in the chamber, and the fluid pressure tends to move the piston towards the plunger. A spring tends to move the piston away from the plunger, against the fluid pressure. The plunger is axially registered in the chamber in discrete plunger positions, and each plunger position sets a discrete limit on axial movement of the piston thereby determining a predetermined flow characteristic of the fluid dispensed via the outlet.

U.S. Pat. No. 10,364,136 discloses a valve device configured to interact with an inlet stream, the inlet stream having a first pressure, the valve having an outlet area with an outlet stream, the outlet stream having a separate pressure and a solenoid configured to interact with the outlet stream.

Each of the above patents are incorporated by reference in their entireties.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

It has been identified that a fluid control system that addresses the shortcomings of existing technologies by providing a mechanism for maintaining fixed flow ratios between different fluid components. Such a system would reduce the need for manual adjustments and recalibration, thereby enhancing consistency and reliability in fluid dispensing applications. By incorporating fixed flow controls and reusable flow inserts, the system could offer improved operational efficiency and product quality, while minimizing maintenance requirements and associated costs.

An example of a beverage dispensing valve includes a valve body that defines a syrup flow path between a syrup inlet and a syrup outlet. An orifice is removably positioned within the valve body along the syrup flow path, and a nozzle is in fluid communication with the orifice. The valve also includes a diluent flow restrictor to regulate the flow of a diluent through the nozzle and a syrup flow restrictor to regulate the flow of syrup through the orifice.

In another example, the beverage dispensing valve features a syrup flow path extending from a syrup inlet to a syrup outlet, with a syrup flow restrictor along the path to receive syrup under pressure. A flow control lock is secured to the syrup flow restrictor to obstruct adjustment of the syrup flow. A nozzle is arranged downstream of the syrup outlet to receive both syrup and diluent flows. An orifice is removably positioned within the flow path between the syrup flow restrictor and the nozzle, selected from a plurality of orifices to provide a specified flow ratio between syrup and diluent.

In further examples, the orifice may be positioned within an aperture seat along the flow path and constructed from materials such as high-density polyethylene or low-density polyethylene. The flow control lock may be configured to physically obstruct or impair access to manual adjustment of the syrup flow restrictor, with tamper-evident features.

A diffuser may be positioned between the nozzle and the syrup flow restrictor. A valve body may define a housing aperture, where the diffuser includes a diffuser stem, and the orifice is positioned within the housing aperture, engaging the end of the diffuser stem inserted therein. The syrup flow restrictor may include a chamber, a sleeve within the chamber, a piston within the sleeve, and a flow control screw mechanically connected to the piston by a spring, with the flow control lock maintaining the position of the flow control screw relative to the chamber. A valve body may be connected in the syrup flow path between the syrup outlet and the syrup flow restrictor, with the orifice positioned upstream of a valve within the housing. A valve body may be connected in the syrup flow path between the syrup outlet and the syrup flow restrictor, with the orifice positioned downstream of the valve between the valve and the syrup outlet.

Various other features, objects, and advantages will be made apparent from the following description taken together with the drawings.

### BRIEF DESCRIPTION OF THE DRAWINGS

FIG. 1 is a front perspective view of an example beverage dispensing valve.

FIG. 2 is side perspective view of an example beverage dispensing valve with the cover removed.

FIG. 3 is a front view of the beverage dispensing valve of FIG. 2.

FIG. 4 is a sectional view taken along line 4-4 of FIG. 3.

FIG. 5 is a sectional view taken along line 5-5 of FIG. 3.

FIG. 6 is a front sectional view taken along line 6-6 of FIG. 2.

FIG. 7 depicts a first example of an orifice.

FIG. 8 depicts a second example of an orifice.

FIG. 9 is a schematic diagram of an example of a multi-flavor beverage dispensing valve.

FIG. 10 is a detailed partial sectional denoted by line 10-10 of FIG. 6.

FIG. 11 is a perspective view of an example of a flow control lock on a flow restrictor.

FIG. 12 is a perspective view of another example of a flow control lock on a flow restrictor.

### DETAILED DESCRIPTION

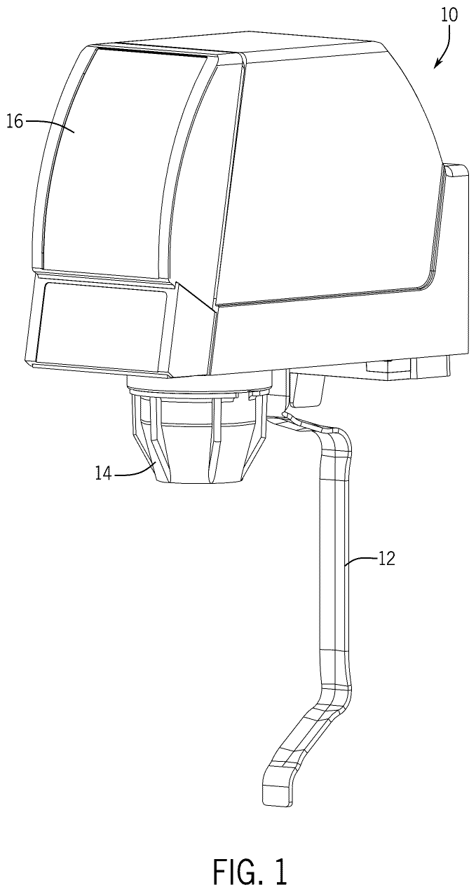

Beverage dispensing valves are commonly used in the industry for dispensing post-mix beverages to an operator or consumer. The valve FIG. 1 is a front perspective view of an example of a beverage dispensing valve 10. The valve 10 receives two independent pressurized fluids (e.g. flavor syrup and carbonated water) and dispensing a mixed beverage formed from the two fluids at a flow rate (e.g. ounces per second) and a flow ratio (e.g. 3:1, 4:1, 5:1). The valve 10 exemplarily includes an actuator 12, which as depicted in FIG. 1, may be a lever arm. The actuator 12 may alternatively be an optical or ultrasonic sensor to detect the presence of a cup or other receptacle in a position below the valve 10. The valve 10 further includes a nozzle 14. The nozzle 14 configured to dispense the mixed beverage, and/or to dispense the pressurized fluids to form the beverage. A cover 16 exemplarily protects and conceals the internal components of the valve 10 as shown and described in further detail herein.

In a typical valve, the valve is manually calibrated to adjust/set the flow rate and the flow ratio. In an example, this may occur upon installation of the beverage dispensing valve by connecting the beverage dispensing valve to the local water supply which may vary in water pressure from location to location. Additionally, different syrups may have different available flow rates at the beverage dispenser and a required flow ratio to meet the specification for a particular branded beverage. Therefore set-up of the beverage dispensing valve typically requires manual field adjustment to the flow of the two fluids independently of each other in order to achieve the specified ratio between the fluids for a particular beverage.

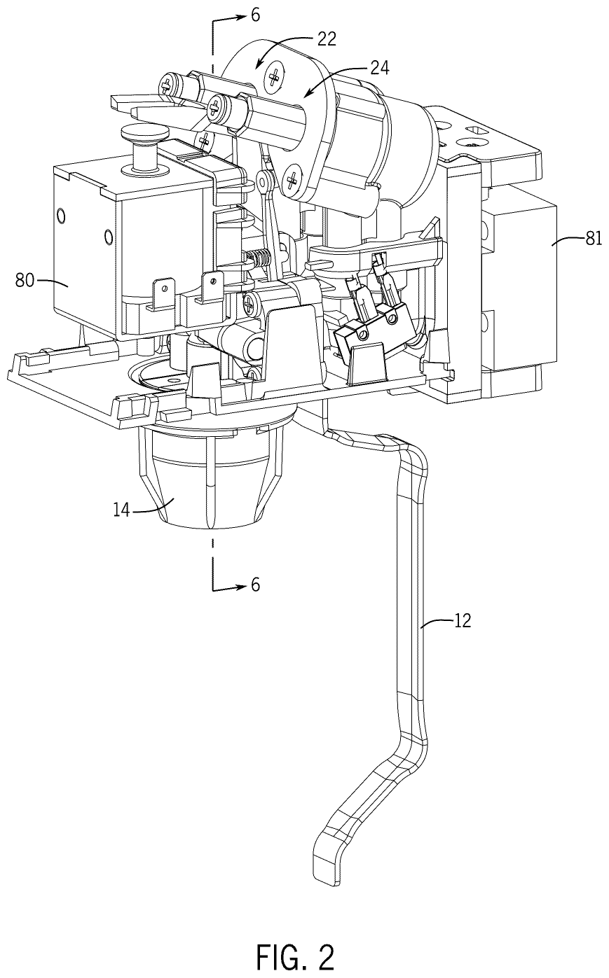

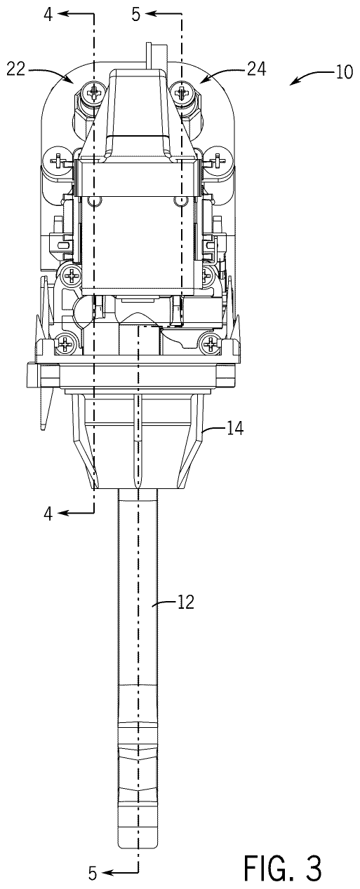

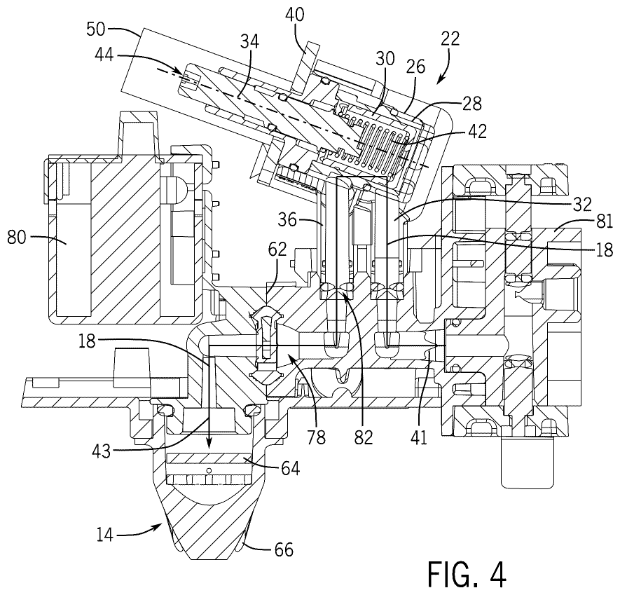

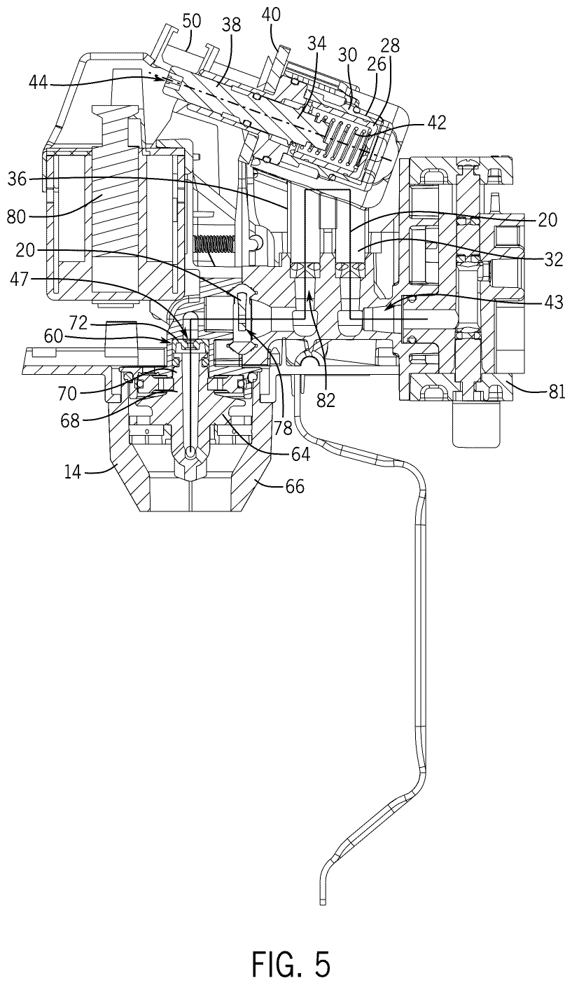

A beverage dispensing valve 10 as disclosed in further detail herein is presented to simplify the valve installation process, change the configuration of the valve 10 to dispense a different beverage, or to maintain valve operation. FIG. 2 is a side perspective view of an example beverage dispensing valve 10 with the cover removed and FIG. 3 is a front view of the beverage dispensing valve 10. FIG. 4 is a sectional view taken along line 4-4 of FIG. 3, the sectional view exemplarily showing a diluent flow path 18 of a diluent (e.g. carbonated or still water) through the valve 10. The diluent flow path 18 exemplarily extends from a diluent inlet 41 at a backblock 81 connected to the valve 10 to a diluent outlet 43 near the nozzle 14. FIG. 5 is a sectional view taken along line 5-5 of FIG. 3, the section view exemplarily showing a syrup flow path 20 of a syrup through the valve 10. The syrup flow path 20 exemplarily extends from a syrup inlet 45 at a the backblock 81 connected to the valve 10 to a syrup outlet 47 near the nozzle 14.

The valve 10 includes a diluent flow restrictor 22 and a syrup flow restrictor 24. Like reference numbers are used to describe the like internal components between the diluent flow restrictor 22 and the syrup flow restrictor 24. Each flow restrictor exemplarily includes a housing 27 that defines a chamber 26. In an example, the housing 27 is a common housing between the diluent flow restrictor 22 and a syrup flow restrictor 24. In another example, a separate housing 27 may be provided for each of the diluent flow restrictor 22 and a syrup flow restrictor 24. A sleeve 28 is positioned within the chamber 26 and a piston 30 is positioned within the sleeve 28. The piston 30 is subjected to a fluid pressure exerted by the fluid received via the inlet 32. The position of the piston 30 along axis 34 of the chamber 26 determines a flow characteristic (e.g. flow rate, volume) of the fluid passing from the inlet 32 through the chamber 26 to the outlet 36. A flow control screw 38 extends exterior from a sub-valve face 40. The flow control screw 38 is mechanically engaged with the piston 30 through a spring 42. Fluid in the chamber 26 exerts a fluid pressure on the piston 30 which moves the piston 30 along the axis 34 and this force is translated to the flow control screw though the spring 42. The flow control screw 38 exemplarily includes a screw head 44 or other point of manual contact whereby rotation of the flow control screw 38 translates the flow control screw 38 along axis 34 to position the spring 42 and piston 30 within the chamber 26, thus manually setting the flow characteristic of the fluid. While the examples above have been provided for the diluent flow restrictor 22 and the syrup flow restrictor 24, it will be recognized that other sub-valve arrangements and constructions may be used while remaining within the scope of the present disclosure.

As disclosed herein, a flow control lock 50 is added to each of the diluent flow restrictor 22 and the syrup flow restrictor 24. The purpose of the flow control lock 50 is to effectively disable the adjustable nature of each of the flow restrictors 22, 24. This disabling of the adjustable nature of the flow restrictors includes physical blockage of the flow control screw 38 or may be a physical limitation of manual access to the adjustment of the flow restrictor(s). In examples, the flow control lock 50 may be an epoxy, an ultrasonic weld, or a heat stake that fixes the flow control screw 38 in position relative to the chamber 26 or obstructs manual access to the flow control valve. In still further examples, the flow control lock 50 may be a physical clip, clamp, retainer, or other physical component that either fixes the flow control screw 38 in position relative to the chamber 26, or obstructs manual access to the flow control screw 38, preventing adjustment of the flow restrictor. The flow control lock 50 may be tamper-evidently removable, whereby the flow control lock 50 is destroyed, deformed, or otherwise perceptibly changed when the flow control lock 50 is removed from engagement with the flow restrictor. In such an example, the flow control lock 50 therefore obstructs manual access to the flow control screw 38 to prevent user manipulation, while the flow control lock may be removed by a maintenance technician for service or remanufacture and the temper-evident flow control lock 50 is replaced with a new flow control lock after service or remanufacture to obstruct future manual access.

In various embodiments, the flow control lock may be attached to the flow restrictor through several methods to ensure secure fixation of the flow control screw. One example involves the use of an adhesive or epoxy bonding or ultrasonic or heat thermoplastic welding to provide a robust attachment that resists tampering, but is tamper-evident upon removal. In another example, the flow control lock 50 may be attached to the flow restrictor via a snap-fit mechanism, where the flow control lock 50 is designed with resilient tabs that engage with corresponding resilient receptacles on the flow control valve, providing a secure yet removable attachment. It will be recognized that these features may be reversed with the tab or tabs oriented on the flow restrictor and the receptacle or receptacles oriented on the flow control lock 50. Such tabs and/or receptacles may be resiliently deformable to facilitate initial connection, but such connection may not be reversible without damage to the tabs/receptacles to make the flow control lock tamper-evident.

In use, the flow control screw 38 is set in an initial calibration to a predetermined flow rate for each of the diluent flow restrictor 22 and the syrup flow restrictor 24. The calibration is exemplarily either during initial construction or assembly of the valve 10, or in the field as part of a retrofit or service of the valve 10. As an example, the flow control screw 38 of the diluent flow restrictor 22 is set to a 2.5 oz/second flow rate while the flow control screw 38 of the syrup flow restrictor 24 is set to a 0.5 oz/second flow rate for a 5:1 mixing ratio and a total 3.0 oz/second beverage flow rate. The flow control locks 50 are then installed on the flow control screws 38 to prevent further changing of the these flow rates either by fixing the flow control screws in these calibrated positions or by preventing further manual access to the flow control screws to obstruct adjustment.

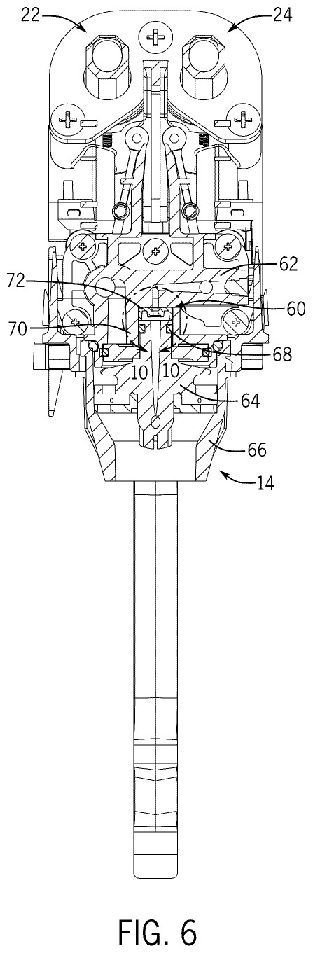

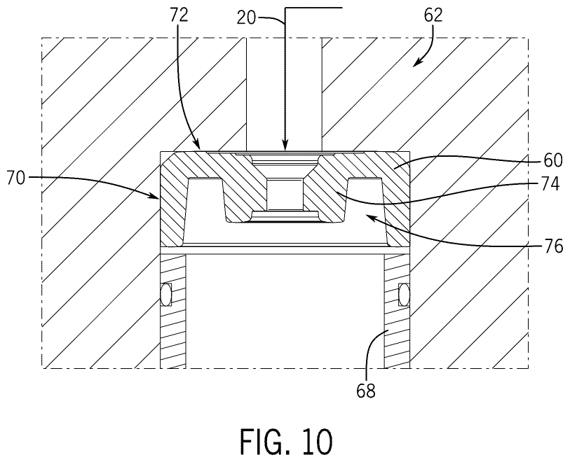

With the respective flows of the syrup and the diluent fixed and with further manual adjustment of the syrup and/or diluent flow obstructed as set forth above, in-field adjustment of the syrup-diluent mixing ratio may be achieved with the selective insertion of one or more orifices 60 within the valve 10. Exemplarily, an orifice 60 is placed downstream of the syrup flow restrictor 24, but upstream of the nozzle 14. It will be recognized that the orifice 60 may be located in various positions between those components besides the specific examples directly provided herein. The orifice 60 is exemplarily constructed of a rigid material, which may be, but is not limited to, plastic which may include HDPE or LDPE. As shown in FIG. 5, the orifice 60 is positioned between the valve body 62 and a diffuser 64 of the nozzle 14. This is additionally shown in FIG. 6 which is a front sectional view taken along line 6-6 of FIG. 2. FIG. 10 is a detailed sectional view, for example as indicated with line 10-10 in FIG. 6, of the connection between the diffuser 64 and the valve body 62.

As depicted in FIGS. 5 and 6, the nozzle 14 includes a nozzle shroud 66 and the diffuser 64. The orifice 60 is exemplarily positioned between the valve body 62 and the diffuser 64. The valve body 62 defines at least a portion of the syrup flow path 20. The valve body 62 further defines a housing aperture 70 at a nozzle end of the syrup flow path 20. The housing aperture 70 further defines an aperture seat 72. The diffuser 64 has a diffuser stem 68 that is received within the housing aperture 70. The orifice 60 is exemplarily positioned within the housing aperture 70 at the aperture seat 72 about the outlet of the syrup flow path 20. The orifice 60 is exemplarily press-fit into the aperture seat 72. After the orifice 60 is seated into place in the aperture seat 72, then the diffuser 64, and more specifically, the stem 68 of the diffuser 64 is inserted into the housing aperture 70. The stem 68 is exemplarily dimensioned so as to leave a gap between the orifice 60 and the stem 68 of the diffuser 64, while in other examples, the orifice 60, seated in the aperture seat 72, is in contact with the stem 68, or in still further examples, the orifice 60 may be physically connected to the stem 68 and inserted into the housing aperture 70 along with the stem 68.

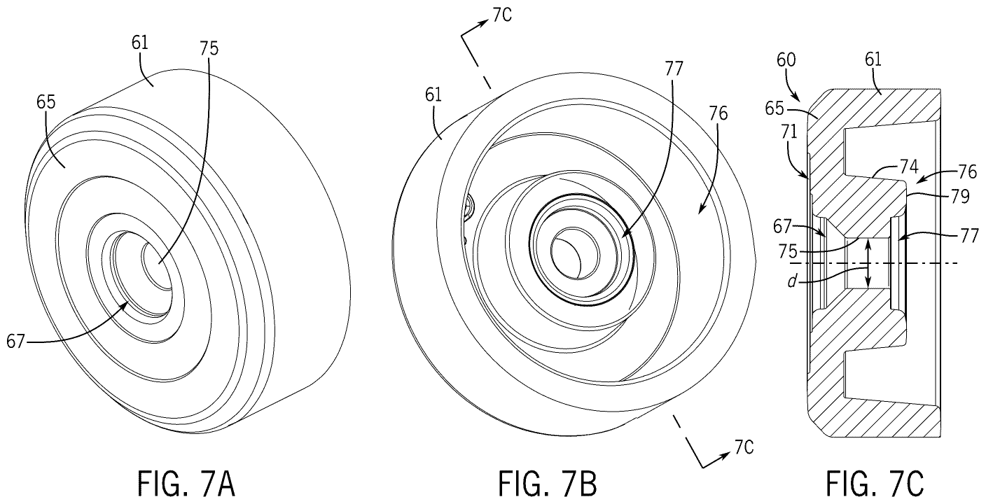

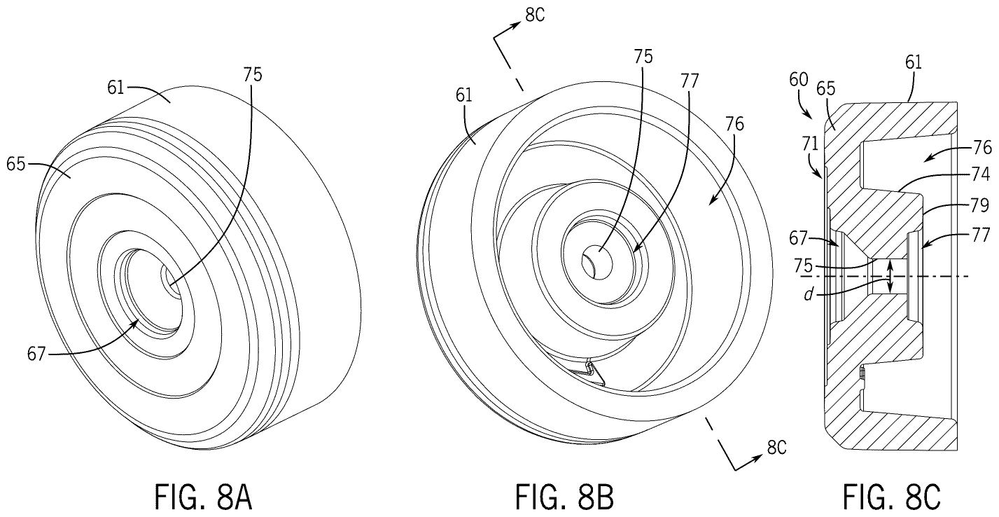

FIGS. 7 and 8 provide perspective and sectional views of two examples of orifices 60 as may be used within the present disclosure. The orifice 60 includes side wall or side walls 61 which define an external diameter of the orifice. While the orifice 60 is depicted as being circular and/or cylindrical in shape, it will be recognized that the orifice 60 may have other shapes, including but not limited to ovular, square, or rectangle, and other shapes will be recognized by a person of ordinary skill based upon the present disclosure. The side wall or side walls 61 exemplarily fit radially interior of side wall of the aperture 70. An end wall 65 of the orifice 60 exemplarily sits against the aperture seat 72 in axial alignment with the outlet 25 of the syrup flow path 20.

A funnel portion 67 extends from an outer face 71 of the end wall 65 interior of the end wall 65 and the orifice 60 to a hole 75. The funnel portion 67 is axially aligned with the hole 75 and exemplarily axially aligned with the side wall 61 from the end wall 65. The funnel portion 67 tapers in a radially interior direction to the hole 75. The hole 75 has an orifice diameter (d) which is the inside diameter of the hole 75. An interior wall 74 at least partially defines the hole 75. In an example, the interior wall 74 is a portion of the end wall 65, for example if the end wall 65 has a thickness in the depth dimension (e.g. axial dimension of the hole 75) co-extensive with the interior wall 74. An exit flare 77 is axially aligned with the hole 75 and tapers radially outward from the inside diameter of the hole 75 to an interior surface 79 of the end wall 65 or the interior wall 74 of the end wall 65. The exit flare 77 helps to diffuse the flow of syrup exiting the hole 75. The orifice diameter (d) defines a nominal flow rate through the orifice, particularly for a known calibrated flow rate setting at the syrup flow restrictor 24. The material and construction of the orifice, exemplarily including, but not limited to the hole 75, orifice side wall 61, and the interior wall 74 may further contribute to define the nominal flow rate through the orifice.

In operation, the orifice 60 with the defined orifice diameter (d) works in compliment with the syrup flow restrictor 24 including the piston 30, sleeve 28, and spring 42, and as set by the flow control screw 38 as described above to provide a consistent flow therethrough. The orifice 60 defines the nominal flow rate while the syrup flow restrictor 24 operates to even or dampen any changes in line pressure upstream of the orifice 60. In examples, the orifices 60 are designed in a poka yoke arrangement to ensure proper orifice placement and seating within the housing aperture 70 and/or aperture seat 72. In an example, the orifice 60 defines an internal cavity 76. As previously noted, the orifice may be press-fit into the housing aperture 70 and exemplarily in contact with the aperture seat 72. This also provides one example of the orifice 60 being removable for replacement, without damaging orifice 60, making it available for reuse.

In practice, the valve can be configured before sale or in the field for a particular type of syrup viscosity and mixing ratio by replacing the orifice 60 from a set of pre-prepared orifices. The orifices may be color coded or otherwise indicated of various specifications to provide the syrup flow resistance to control syrup flow to the intended beverage specification.

As seen in FIGS. 4 and 5, the valve body 62 contains a respective flow valve 78 for each of the diluent and the syrup. Coordination between actuator 12 and a solenoid 80 drives actuation of the flow valves 78 to dispense the beverage. While FIGS. 5 and 6 depict the placement of the orifice 60 between the stem 68 of the diffuser 64 and the valve body 62, it will be recognized that the orifice 60 may be placed and/or components configured to receive the orifice 60 in such other placed in many locations along the flow path 20 between the syrup flow restrictor 24 and the nozzle 14. Thus an aperture housing 70 and/or aperture seat 72 may be formed at interfaces between components, examples of such places include on either side of the valve 78, at the interface 82 between the outlet 36 of the syrup flow restrictor 24 and the valve body 62, or a part of the outlet 36 of the syrup flow restrictor 24. It will be recognized that in any of these, or other locations along a flow path 20, in the valve body 62, the valve body 62 may be sized or dimensioned such as to removably receive an orifice 60 along the flow path 20. This may include the provision of access, for example as described above with respect to the housing aperture 70 and/or aperture seat 72. Another form of aperture 70 and/or aperture seat 72 may be formed elsewhere along the flow path 20 and sized and dimensioned such as to removably receive an orifice therein as will be recognized by a person of ordinary skill in the art based upon the present disclosure. This aperture 70 and/or aperture seat 72 may be a dedicated portion formed in the valve body 62 or one of the other components along the syrup flow path 20 e.g. the valve 78, outlet 36 or flow restrictor 24. Such aperture/aperture seat incorporates access thereto in the form of e.g. an opening, seam, or door whereby the orifice may be interchanged as described above.

While the present disclosure has focused on placement of the orifice 60 in the flow path 20 of the syrup, it will be recognized that in other examples, the diluent may be additionally controlled through similar use and placement of an orifice 60 within the flow path 18 of the diluent. Still further examples may include orifices 60 as described herein positioned along both of flow path 18 and flow path 20.

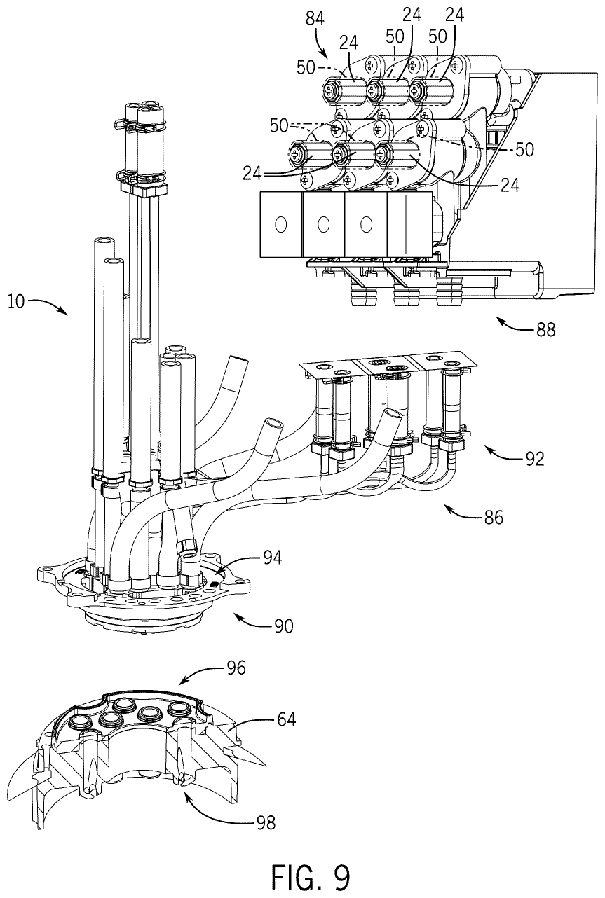

The above examples have been provided with respect to a single-syrup beverage dispensing valve 10. However, it will be recognized that a similar configuration may be used with muti-flavor dispensers as well. FIG. 9 is a schematic diagram of a multi-flavor beverage dispensing valve 10, which depicts similar components, but arranged for a beverage dispensing valve 10 configured to control the dispense of one or more syrups to create a beverage of a plurality of beverages which may be dispensed sequentially from the same valve 10. The valve 10 includes a plurality of syrup flow restrictors 24, for example in a multi-flavor valve arrangement 84. Each of these syrup flow restrictors having a flow control lock 50 securing the calibrated flow control screw 38 from being moved as described above. Each syrup flow restrictor 24 receives and initially controls the flow of a different syrup for combination with a diluent to form a beverage. Tubing 86 connects the outlets 88 of the syrup flow restrictors 24 to a manifold 90 which in turn connects each syrup flavoring to the diffuser 64 within the nozzle. As described above, an orifice (not depicted in FIG. 9, but depicted and described above) is positioned between any of these components to provide the flow control of the syrup in the valve 10. The orifice may be positioned at the interface between the outlets 88 and the inlets 92 of the syrup tubing. The orifice may be positioned within the tubing 86, as part of a molding process or as an in-line component secured to tubing portions. The orifice may be positioned at an interface 94 between the tubing and the manifold 90. The orifice may be positioned at the interface 96 between the manifold 90 and the diffuser 64 or the orifice may be positioned at the syrup stems 98 within the diffuser 64.

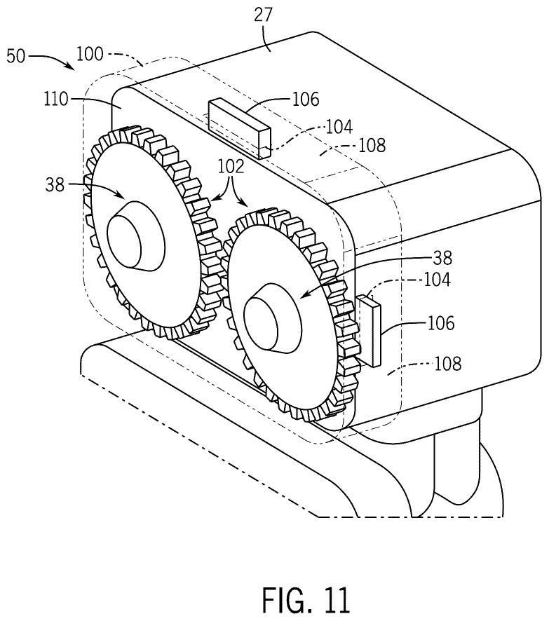

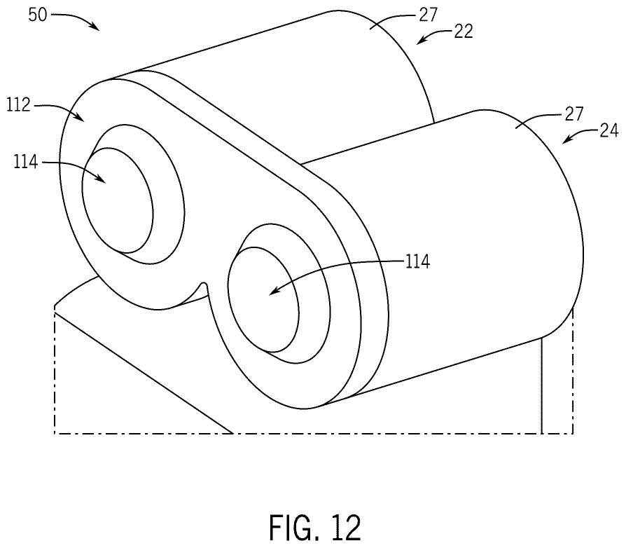

FIGS. 11 and 12 provide additional examples of the flow control lock 50 on examples of the flow restrictor. The flow control lock 50 as described is capable to disable the adjustable nature of the flow restrictors 22, 24 in beverage dispensing valves 10 by physically blocking or limiting manual access to the flow control screws 38 or other adjustable component, for example in a tamper-evident manner. The flow control lock 50 can be implemented using various methods such as epoxy, ultrasonic welds, heat stakes, or a physical cover, and it may include tamper-evident features to indicate if it has been removed. FIG. 11 is a perspective view of an example of a flow control lock 50 in the form of a cover 100. In the example shown, the diluent flow restrictor and the syrup flow restrictor are within a common housing 27. The respective flow control screws 38 extend exterior of the housing 27 for adjustment either during a calibration process, a repair or remanufacturing process, or by a technician for maintenance, if needed. The flow control screws 38 exemplarily include teeth 102 which may facilitate gripping of the screw for manual adjustment and/or provide indications of incremental arcs of rotation for fine adjustment of the screw 38. The cover 100 exemplarily includes a face 110 and side walls 108. The face 110 and the side walls 108 are dimensioned to fit over the flow control screws 38 and a portion of the housing 27. The flow control screws 38 within the interior of the cover 100 prevents access to the flow control screws 38 for manual or accidental adjustment. The cover 100 further includes slots 104 which are shaped and dimensioned to receive projections 106 extending from the housing 27. It will be recognized that the slots 104 and the projections 106 may be reversed. In the example shown, the side walls 108 deflect over the projections 106 until the projections 106 extend through the slots 104, securing the cover 100 to the housing 27 at a position over the flow control screws 38. The cover 100 may be constructed so that upon removal of the cover 100, the cover 100 is irreversibly deformed or destroyed or the projections are irreversibly deformed or destroyed, indicating that the cover 100 has been removed.

In still further examples, the cover 100 as depicted may be secured to the housing 27 in other manners while remaining within the scope of the present disclosure. The cover 100 may be secured to the housing 27 with glue or adhesive. The cover 100 may be secured to the housing 27 with ultrasonic welding. The cover 100 may be secured to the housing 27 using tamper-evident tape. Such securements between the cover 100 and the housing 27 may be tamper-evident in the sense that the securement may be broken to remove the cover 100, but will be visibly and/or physically indicate such removal.

FIG. 12 depicts still further examples of the flow control lock 50. In FIG. 12 reference numerals 112 and 114 are used to denote structures which may serve different purposes in different embodiments of the flow control lock 50. In each of the examples reference numeral 112 represents a various form of cover, for example, as described above with respect to FIG. 11. In a first example, reference numerals 114 represents the screw of the diluent flow restrictor 22 and the screw of the syrup flow restrictor 24, which are exemplarily contained within separate housings 27. These may be packaged within a single housing as shown in FIG. 11. The cover 112 is secured to the housings 27, for example in the manners as described above. The cover 112 has teeth to interlock with corresponding teeth extending radially outward from the head of the screw to lock the screw against rotation.

In a second example, a cover 112 is secured to the housings 27, for example in the manners as described above. Reference number 114 represents a cover as well, which is shaped and dimensioned to fit over the outside of the screw (not shown, below 114), for example by press-fitting, to prevent rotation of the screw. The two covers represented by reference numerals 112 and 114 interlock to further limit rotation of the screw. In a related example, the covers represented by reference number 114 are secured to the screws first and the cover 112 is secured over them and to the housings 27 to prevent removal of the covers 114.

In a third example, reference number 114 represents a more permanent blockage of rotation of the screw by glue, epoxy, ultrasonic welding, heat staking, or the like. The cover 112 may be secured to the housings 27 in the manners as described above to provide a surface and/or material to which the permanent blockage can be secured.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives and modifications are possible within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A beverage dispensing valve comprising:
a valve body that at least partially defines a syrup flow path therethrough between a syrup inlet and a syrup outlet;
an orifice removably disposed within the syrup flow path;
a nozzle in fluid communication with the orifice;
a diluent flow restrictor configured to regulate the flow of a diluent through the nozzle; and
a syrup flow restrictor configured to regulate the flow of syrup through the orifice.

2. The beverage dispensing valve of claim 1, wherein the valve body defines an aperture seat along the flow path and the orifice is configured to be removably disposed within the aperture seat.

3. The beverage dispensing valve of claim 1, wherein the orifice is a first orifice of a plurality of orifices, the plurality of orifices each have orifice holes of different inside diameters.

4. The beverage dispensing valve of claim 1, wherein the orifice is constructed of plastic.

5. The beverage dispensing valve of claim 4 wherein the plastic comprises high density polyethylene (HDPE) or low density polyethylene (LDPE).

6. The beverage dispensing valve of claim 1, wherein the orifice comprises a sidewall defining an outer perimeter of the orifice and an end wall internal of the sidewall, wherein a hole is defined through the end wall, the hole having an inside diameter.

7. The beverage dispensing valve of claim 6, wherein a funnel portion extends along an axis of the hole from an outer face of the end wall interior of the end wall to the hole.

8. The beverage dispensing valve of claim 7, wherein an exit flare is located along the axis of the hole and extends radially outwards from the hole to an inner face of the end wall.

9. The beverage dispensing valve of claim 1, further comprising a flow control lock arranged about at least a portion of the syrup flow restrictor, the flow control lock configured to obstruct adjustment of the flow of syrup through the syrup flow restrictor.

10. The beverage dispensing valve of claim 9, wherein the flow control lock is a first flow control lock and further comprising a second flow control lock arranged about at least a portion of the diluent flow restrictor.

11. The beverage dispensing valve of claim 10, wherein the first flow control lock and the second flow control lock are a unitary construction.

12. The beverage dispensing valve of claim 9, wherein the flow control lock is configured to physically obstruct adjustment of the flow through the syrup flow restrictor.

13. The beverage dispensing valve of claim 9, wherein the flow control lock is configured to impair access to manual adjustment of the flow through the syrup flow restrictor.

14. The beverage dispensing valve of claim 13, wherein the flow control lock is configured to have a tamper-evident construction.

15. A beverage dispensing valve comprising:
a syrup flow path extending from a syrup inlet to a syrup outlet;
a syrup flow restrictor along the syrup flow path and configured to receive a flow of syrup under pressure through the syrup flow path;
a flow control lock secured to the syrup flow restrictor and configured to obstruct adjustment of the flow of syrup through the syrup flow restrictor;
a nozzle arranged downstream of the syrup outlet and configured to receive the flow of the syrup and configured to receive a flow of diluent; and
an orifice removably positioned within the flow path between the syrup flow restrictor and the nozzle, the orifice selected from a plurality of orifices to provide a specified flow ratio between the flow of the syrup and the flow of the diluent.

16. The beverage dispensing valve of claim 15, further comprising a diffuser between the nozzle and the syrup flow restrictor, wherein the orifice is positioned between the syrup outlet and the diffuser.

17. The beverage dispensing valve of claim 16, further comprising a valve body comprising a housing aperture and the diffuser comprises a diffuser stem, wherein the orifice is positioned within the housing aperture in engagement with an end of the diffuser stem inserted within the housing aperture.

18. The beverage dispensing valve of claim 15, wherein the syrup flow restrictor further comprises:
a chamber;
a sleeve positioned within the chamber;
a piston within the sleeve; and
a flow control screw mechanically connected to the piston by a spring;
wherein the flow control lock is configured to maintain a position of the flow control screw relative to the chamber.

19. The beverage dispensing valve of claim 15, further comprising a flow valve connected in the syrup flow path between the syrup outlet and the syrup flow restrictor, wherein the orifice is positioned in the flow path on an upstream side of the flow valve between the flow valve and the syrup flow restrictor.

20. The beverage dispensing valve of claim 15, further comprising a flow valve connected in the syrup flow path between the syrup outlet and the syrup flow restrictor, wherein the orifice is positioned in the flow path on a downstream side of the flow valve between the flow valve and the syrup outlet.
